(19) United States
(12) Patent Application Publication
(10) Pub. No.: US 2021/0340694 A1
(43) Pub. Date: Nov. 4, 2021

(54) METHOD FOR REDUCING ERRORS IN TEXTILE MACHINES

(71) Applicant: Saurer Spinning Solutions GmbH & Co. KG, Uebach-Palenberg (DE)

(72) Inventor: Thomas ARTER, Schwalmtal (DE)

(21) Appl. No.: 17/283,238

(22) PCT Filed: Oct. 9, 2019
(86) PCT No.: PCT/EP2019/077370

§ 371 Date: Apr. 6, 2021

(30) Foreign Application Priority Data
Oct. 10, 2018 (DE) 10 2018 125 064.9

(51) Int. Cl. D01H 13/14; D01G 31/00; B65H 63/00; G09B 19/24

(52) U.S. Cl. CPC D01H 13/14; D01G 31/00; B65H 2701/31; G09B 19/24; B65H 63/00

(57) ABSTRACT

The invention relates to a method for reducing errors in textile machines via training management of the operating personnel. In order to provide a method and a system which reduce the number of errors occurring and thereby guarantee the desired product quality, as well as reducing costly repairs and long downtimes of the textile machine and thereby lowering operating costs and

increasing efficiency and operating safety, according to the invention, as method steps, the method first involves error detection at at least one textile machine, followed by detecting error information when an error occurs, wherein the detected error or error information is subsequently aligned with available instructional and/or training content and/or already known error information, and an item of instructional and/or training content relating to a possible cause of the error is identified for future error prevention, and finally the instructional and/or training content for error-specific training or training prompted by the error is delivered to the operating personnel in order to prevent a future occurrence of the error, improve the operating competency of the operating personnel and/or increase the operating safety.

### CROSS-REFERENCE TO RELATED APPLICATIONS

This application claims priority from PCT International Patent Application No. PCT/EP2019/077370, filed Oct. 9, 2019, which claims priority from German National Patent Application No. 10 2018 125 064.9, filed Oct. 10, 2018, entitled “Verfahren Zur Fehlerreduzierung Bei Textilmaschinen”, the entire contents of which are incorporated herein by reference.

### FIELD OF THE INVENTION

The invention relates to a method for reducing errors in textile machines by managing the teaching of the operating personnel and a corresponding system for reducing errors.

### BACKGROUND OF THE INVENTION

Textile machines such as spinning machines are often operated in foreign countries and by untrained operating personnel. Furthermore, the operating personnel of textile machines changes frequently, and therefore the state of training and of knowledge of the entire operating personnel can differ greatly. Newly hired operating personnel often lack even basic knowledge in the operation of textile machines. As a result, operating errors regularly occur, which in turn cause errors and defects in the textile machines and in the textile products produced thereby, in particular yarns, twisted yarns and fabrics. These errors and defects lead not only to reduced product quality and to a reduced amount of product in the desired quality but also to expensive repairs and long downtime of the textile machines, resulting in increased operating costs and reduced economy. Furthermore, errors in textile machines lead to a reduction in operational safety and are associated with an increased risk of injury to the operating personnel.

German Patent Publication DE 10 2015 106 470 A1 already discloses a method in which communication is established between a superordinate controller of a workstation of a textile machine and a portable communication device of the operating personnel in order to support the operating personnel in correcting the errors that occur. For this purpose, the controller sends a work instruction for performing a work step to the portable communication device of the operator, captures the performance of the work step by means of signals from the defective workstation and/or from the portable communication device and possibly sends a further work instruction for operating the workstation to the portable communication device of the operator as soon as the previous work step has been performed or could not be performed. In this way, the untrained operating personnel should be enabled to correct an error that has occurred and to make the textile machine usable again, even without the competence necessary for this.

The invention therefore addresses the problem of providing a method and a system that reduce the number of errors that occur and thereby ensure the desired product quality, and reduce expensive repairs and long downtime of the textile machine and thereby lower the operating costs, and increase the economy and also increase the operational safety.

### SUMMARY OF THE INVENTION

The problem is solved according to the invention by reducing errors in textile machines by managing the teaching of the operating personnel and a system for reducing errors in textile machines by managing the teaching of the operating personnel. Advantageous developments of the invention are stated herein.

The method according to the invention for reducing errors in textile machines by managing the teaching of the operating personnel comprises, as a first method step, performing error detection on at least one textile machine, followed by capturing error information if an error occurred. Subsequently, the detected error or the error information is compared with available teaching and/or training contents and/or already known error information and a teaching and/or training content relevant to a possible cause of the error is identified for future error avoidance. Finally, the teaching and/or training content for the error-specific further education of the operating personnel or further education of the operating personnel triggered by the error is provided in order to avoid a future occurrence of the error, to improve the operating competence of the operating personnel and/or to increase the operational safety.

The system according to the invention for reducing errors in textile machines by managing the teaching of the operating personnel has a central control unit having at least one interface to a textile machine, more particularly to a local control unit of a textile machine, in order to detect errors and/or to capture error information. Furthermore, the system comprises a central database having teaching and training contents associated with the error information for the further education of the operating personnel for future error avoidance and comprises an output interface for providing teaching and/or training contents for the error-specific further education of the operating personnel or further education of the operating personnel triggered by the error, in order to avoid in future the error that occurred.

The inventors have discovered that, by performing error monitoring and teaching the operating personnel as needed, most of the errors occurring in textile machines can avoided quickly and with little effort. In particular, error-specific teaching of the individual employees enables efficient and quick further education of untrained or underqualified operating personnel. Advantageously, because the number of errors that occur is significantly reduced, the desired product quality can be ensured and expensive repairs and long downtime of the textile machine can be reduced, leading to a reduction in operating costs and an improvement in economy. Furthermore, the operational safety for the operating personnel is increased and therefore the working conditions are significantly improved.

### DESCRIPTION OF THE PREFERRED EMBODIMENTS

The textile machine can initially be any machine of the textile-producing, textile-processing or fibre-material-processing industry. However, a textile machine is preferably a machine having a plurality of identical workstations. The textile machine is particularly preferably a spinning machine, more particularly a ring spinning machine or a rotor spinning machine.

Reducing errors in textile machines by managing the teaching of the operating personnel is understood to mean that errors in the textile machines are detected by means of technical apparatuses and teaching and/or training contents are compiled likewise by means of technical apparatuses, which contents are subsequently provided to the operating personnel, whereby the operating competence of the operating personnel is increased, leading to a reduction in errors occurring during the operation of the textile machines. Thus, in the teaching management, teaching and training contents are imparted to the operating personnel not only in accordance with a fixed scheme or a fixed schedule but at least also as needed, namely as a result of errors that occurred, whereby significantly more efficient and quicker further education including fast imparting of basic knowledge required for operating the textile machines is possible.

An operator or the operating personnel is basically any person who performs actions on the textile machine which are necessary for operating the textile machine and who, in the course thereof, preferably has to perform a plurality of individual work steps of an operating process, which differ according to the situation. The operating personnel can also be divided into groups of different tasks such that an operating personnel group performs only a specific task or tasks of a task field. For example, some of the operating personnel can be responsible for maintenance and/or start-up, while others are active at the textile machine only during ongoing operation.

The term “error” is understood to mean any undesired and/or unplanned operating state of the textile machine, wherein the textile machine can be completely or at least partially serviceable or can have completely failed. An error can be, for example, a defect of the entire textile machine or a part thereof, more particularly one or more of numerous workstations of the textile machine. Alternatively or additionally, an error can also concern the textile processed by the textile machine or the produced product, without the textile machine having a defect, which is the case for example when there is malfunction of a spinning machine with a torn thread. Accordingly, “error detection” is generally understood to mean the determination of these undesired and/or unplanned operating states. This can include monitoring for defects, malfunctions, functional restrictions and/or user errors or operating errors. Error detection can be performed by means of existing sensors and/or cameras or sensors and/or cameras to be additionally arranged on the textile machine. Furthermore, the error detection can be performed in the textile machine itself by means of an internal control unit of the textile machine and/or by means of an external control unit. In addition, it is advantageous if errors can also be reported manually, for example by the operating personnel by entering at the textile machine or at a control unit an undetected error that has occurred.

According to the invention, if an error is detected, error information is captured so that subsequently the error information can be compared and applicable teaching and training contents can be identified. The error information can basically be any information regarding the error that occurred and/or operating data of the textile machine that precede the error, which operating data can be provided by the textile machine or obtained by external means or sensors. In particular, the error information can be information about the operating state of the textile machine and particularly preferably about a deviation from a desired operating state. The error information can include, inter alia, data such as the location of the textile machine, the date and time of day, the operation process during the occurrence of the error, the preceding operating actions of the operating personnel and/or information about preceding maintenance. Technicians and/or experts and/or developers preferably have access to the captured error information, more particularly from a central control unit.

The capturing and optional subsequent preparing of the error information preferably comprise a comprehensive data analysis and/or methods of data mining, i.e. systematic application of statistical methods to all error information. In the preparing or pre-processing of the error information, structured storing of the information in a database or first categorizing of the error information can be performed, for example.

The teaching and training contents are basically contents by means of which knowledge or skills related to the operation and/or the operating of the textile machine can be imparted. The teaching and training contents can be, inter alia, manufacturer information, operation instructions and manuals, operating instructions, checklists and FAQ lists, comprising contents in the form of text, illustrations, photos, animations, videos and/or audio contents. The teaching and training contents are preferably part of a knowledge network including a central (knowledge) database.

The teaching and/or training contents can be continually adapted to the progressing development of the textile machines and/or new findings regarding error avoidance and/or correction. For this purpose, it is advantageous if technicians and/or experts and/or developers can enter new teaching and training contents. It is particularly advantageous if such contents are associated with already known errors or error patterns that the new teaching and training contents should correct or prevent. In particular, it is preferred that the teaching and training contents are modularly constructed, each module especially preferably being matched to a specific textile machine part or to the expansion level of the textile machine. Although a distinction cannot be made between teaching and training in every case, teaching refers more to the theoretical imparting of information and knowledge, while training refers more to the practical performance of exercises and/or the practical imparting of information at the textile machine or at a device that models or simulates a textile machine or a part thereof.

In order to identify teaching and training contents appropriate for a detected error, at least part of the error information is compared with error information of previous errors and/or with stored teaching and training contents, information about previous or predicted errors particularly preferably already being associated with the respective teaching and training contents. In particular, the available teaching and/or training contents are contents provided in a central control unit.

The identifying of a teaching and/or training content relevant to a possible cause of the error generally comprises first performing a user-unspecific selection of teaching and training contents that at least make less probable, and preferably prevent, a recurrence of a detected error, the selection preferably being matched to the particular textile machine or the particular location. The identifying of relevant teaching and/or training contents can be exclusively the finding of solutions to already known errors, but can preferably also comprise the extending of solutions to already known errors to previously unknown but similar errors. Furthermore, a plurality of different teaching and/or training contents can be provided for an error that has occurred and that is identical or similar to already known errors, in order to ensure that comprehensive knowledge is imparted to the operating personnel. Furthermore, in addition to the teaching and/or training contents relevant to the error that has occurred, further teaching and/or training contents forming the foundation for these can also be provided so that basic knowledge necessary for avoiding the error in future can first be imparted.

Teaching and training information can be provided for the operating personnel basically in any manner. The teaching and training information can be provided directly to the operating personnel, more particularly digitally or online, or indirectly by a person conducting the teaching or training, who can access the identified and provided teaching and training information. However, the teaching and training information is preferably provided to the operating personnel directly and particularly preferably in such a way that it can be retrieved by means of mobile and/or wireless communication devices. For this purpose, the teaching and training information is especially preferably centrally retrievable on a web server or from a cloud.

The central control unit is preferably at least one central server having an error database, having a knowledge database which comprises the teaching and training contents and optionally further information and/or having a web server for centrally providing the teaching and training contents. In principle, the error information and the teaching and training contents can also be stored in a common database. Furthermore, the central control unit of the system for reducing errors can have any further functions and in particular can be integrated into the digital infrastructure of a company.

The central control unit has an interface for exchanging data with at least one textile machine, by means of which interface data can at least be received from the textile machine. In order to be able to output the teaching and training information to the operating personnel, the central control unit also has an output interface. The output interface preferably enables playback or the transmission of data to a playback device, more particularly a screen, more particularly a touch-sensitive screen, of the textile machine and/or to a user device, such as a mobile telephone, a tablet, a laptop, some other portable computer, a smartwatch, a smart armband, smart glasses or the like. The interface to the textile machine and/or the output interface is preferably suitable for capturing and outputting data.

A preferred embodiment of the method according to the invention provides that, after the error detection, it is determined whether the error was caused by the operating personnel or could have been prevented by different behaviour of the operating personnel, so that it can be determined whether it is possible to avoid the error in future by means of error-specific teaching and/or training contents. This distinguishing between user-caused errors and other errors preferably occurs in the central control unit. This can be performed automatically or by a technician or other specialist.

The identity of the operating personnel is particularly preferably captured during the use of the textile machine in order to associate a detected error with an individual user or a user group, whereby personalized teaching can be conducted and/or the training can be concentrated on the users who caused errors that occurred. The capturing of the operating personnel can be performed personally for each user individually or as a user group, for example on the basis of the duty rosters and shift schedules. Personal capturing can be performed, for example, by means of logging into the textile machine before the textile machine is used.

In an advantageous development of the method according to the invention, for the error detection the operating actions performed by the operating personnel are monitored in order to associate an error occurring immediately or later with the behaviour of a user or a user group. Operating actions at the textile machine are preferably permanently captured so that an error can be associated even with an operating action not performed immediately before the occurrence or detection of the error. The operating actions can be monitored at the textile machine, more particularly by means of a local control unit, and/or by means of the central control unit, which then particularly preferably has a permanent data connection to the textile machine.

According to another advantageous embodiment of the method according to the invention, after the detection of an error caused by a user the error is associated with the user responsible for the error in a database, and, in particular by means of long-term monitoring of the usage actions of the operating personnel, a competence evaluation of the individual users or user groups is conducted, in which case teaching or training contents can be offered to the users or user groups subsequently in a targeted manner in order to improve the operating competence. It is also advantageous to divide the different users, more particularly automatically, into groups of similar competence or similar teaching or training demand and to subsequently conduct teaching or training in groups and/or on site on the basis of the determined demand. Therefore, the method makes it possible to combine the operating personnel into sensible further-education groups.

It is also advantageous if the teaching and/or training progress is captured for each user or each user group. Furthermore, the participation in and the progress of provided teaching and training contents can be monitored so that the available skills of the operating personnel are known and the operating personnel can accordingly be assigned various activities corresponding to their particular competence.

A particularly preferred development of the method according to the invention provides that, on the basis of the identified teaching and/or training contents, an online teaching is conducted, which the operating personnel, more particularly the error-causing user, are preferably automatically invited to or registered for. The automatic registration and/or invitation can be made for a user group or for a specific user when insufficient competence or insufficient knowledge has been determined. The completion of trainings which are available online has the advantage that these can be executed at any time and in any place by the operating personnel.

Basically, a teaching and more particularly a training can be executed in any way, but it is preferred that a teaching and more particularly a training is executed at the textile machine by means of a portable communication and/or training device, more particularly by means of a mobile telephone app, the teaching and/or training contents preferably being provided by a central control unit. The transferring of teaching and training contents to portable communication and/or training devices makes it possible to access the teaching and/or training contents at any time and in any place, and furthermore the operating personnel can retrieve the teaching and/or training contents on a familiar device, more particularly the mobile telephone of the operating personnel. Moreover, the transferring of teaching and/or training contents to portable communication and/or training devices makes it possible to use not only written contents, which are not understood by some operating personnel with a low level of education, including illiterates, but also contents in the form of videos, audio contents and/or animations, which can be understood regardless of reading ability.

In a preferred embodiment of the method according to the invention, the operating actions of the operating personnel are captured at the portable communication and/or training device and/or at the textile machine during the teaching or the training in order to capture the teaching or training progress and operating errors possibly occurring again, whereby even greater learning progress can be easily achieved. Particularly preferably, errors made again by the user are detected and immediately corrected. Furthermore, the progress of the user in acquiring knowledge and operating competence and/or in the teaching or training progress preferably is captured and is stored in a database, or the database entry of the user or of a user group is expanded and/or updated.

According to an advantageous development of the method according to the invention, maintenance management is performed on the basis of the detected errors, more particularly on the basis of a long-term evaluation of the errors that occurred in a specific textile machine, by providing to the operating personnel teaching and/or training contents regarding the maintenance of the specific textile machine as needed and/or regularly. This applies in particular to errors that were not caused specifically by a user or a user group and/or were not caused by incorrect operation. In this way, future errors due to maintenance not performed or performed too infrequently can also advantageously be avoided.

Two examples of an embodiment of the method according to the invention are explained in more detail below.

In a first embodiment of the method for reducing errors in textile machines by managing the teaching of the operating personnel, a central control computer is connected to a local control computer of a rotor spinning machine having 250 identical spinning boxes via a data interface. In the operation process, errors are detected by the local control computer and optionally further sensors directly connected to the central control computer. With regard to these errors, various information such as the time of day, the number of the spinning box and the type of error are captured as error information. In the central control unit, the error information is regularly evaluated and in the process the detected errors are compared with error information of errors that occurred in the past and it is determined whether teaching or training contents that can prevent the occurrence of these errors in future are available in a central knowledge database.

Subsequently, the teaching and learning contents identified for preventing in future the errors that occurred are provided to the entire operating personnel of this textile machine for retrieval, which retrieval can occur by means of any Internet-capable device, such as a computer or a mobile telephone. The entire operating personnel automatically receives a message with a request to complete the teaching or training at a time selected by the operating personnel within a time period specified in the message.

In a second embodiment of the method, error detection is likewise performed, but the operating personnel are logged into the textile machine before the textile machine is operated and furthermore the operating actions taken by the operating personnel are captured so that operating actions preceding the error and the identity of the user can also be transferred to the central control computer as part of the captured error information.

Subsequently, the error information is compared as in the previous example in order to identify teaching and training contents that can be associated with the error. If such contents cannot be identified, a message is transmitted to an expert team or developer team, which message comprises the error information, so that it can be checked whether corresponding teaching and training contents can be created and entered into the system. If, on the other hand, suitable teaching and training contents are found, they are provided to the user who caused the error. Furthermore, it is checked whether the error that occurred is of general importance and whether accordingly the teaching and training contents should be provided to a user group or to the entire operating personnel.

Along with the comparison of the error information, it is checked whether the error was caused by the usage actions of the user or could have been prevented by different user behaviour. If the error was not caused by the user, it is checked whether the error could have been avoided by maintenance measures. If this is the case, teaching and training contents giving the instruction to perform maintenance are provided at least to the operating personnel responsible for the maintenance of the textile machine, and possibly to the entire operating personnel. Alternatively or additionally, experts and/or technicians and/or developers are also informed in order to find a permanent solution for avoiding the error not caused by a user and possibly to develop corresponding teaching and training contents.

If the error was caused by the user, first the lacking knowledge of this user which led to the error is captured in a competence database. Subsequently, corresponding teaching and training material is provided to the user. This can occur as an online teaching to be executed on a mobile telephone or a computer of the user, the execution and course of which online teaching are monitored by the central control unit, the progress of the user likewise being captured in the competence database. In addition or alternatively, a training and/or a teaching can also occur on site and/or at the textile machine, which training and/or teaching can be an individual further-education measure or an event in a group of users. The participation in and the achieved progress of the further-education measure are subsequently captured in the competence database so that the newly acquired knowledge and skills of the user are documented.

1. A method for reducing errors in textile machines by managing the teaching of the operating personnel, comprising:
performing error detection on at least one textile machine,
capturing error information when an error occurs,
comparing the detected error with available teaching and/or training contents and/or already known error information and identifying a teaching and/or training content relevant to a possible cause of the error, for future error avoidance, and
providing teaching and/or training contents for the error-specific further education of the operating personnel in order to avoid in future the error that occurred.

2. The method according to claim 1, characterised in that, after the error detection, it is determined whether the error was caused by the operating personnel or could have been prevented by different behaviour of the operating personnel.

3. The method according to claim 1, characterised in that the identity of the operating personnel is captured during the use of the textile machine in order to associate a detected error with an individual user or a user group.

4. The method according to claim 1, characterised in that, for the error detection, the operating actions performed by the operating personnel are monitored in order to associate an error occurring later with the behaviour of a user or a user group.

5. The method according to claim 1, characterised in that, after the detection of an error caused by a user, the error is associated with the user responsible for the error in a database, and, in particular by means of long-term monitoring of the usage actions of the operating personnel, a competence evaluation of the individual users or user groups is conducted, whereby subsequently teaching or training contents can be offered to the users or user groups in a targeted manner in order to improve the operating competence.

6. The method according to claim 1, characterised in that, on the basis of the identified teaching and/or training contents, an online teaching is conducted, which the operating personnel are preferably automatically invited to or registered for.

7. The method according to claim 1, characterised in that a teaching and more particularly a training is executed at the textile machine by means of a portable communication and/or training device, more particularly by means of a mobile telephone app, the teaching and/or training contents being provided by a central control unit.

8. The method according to claim 1, characterised in that the operating actions of the operating personnel are captured at the portable communication and/or training device and/or at the textile machine during the training in order to capture the training progress and operating errors possibly occurring again.

9. The method according to claim 1, characterised in that maintenance management is performed on the basis of the detected errors by providing to the operating personnel teaching and/or training contents regarding the maintenance of the specific textile machine as needed and/or regularly.

10. A system for reducing errors in textile machines by managing the teaching of the operating personnel, comprising
a central control unit having at least one interface to a textile machine for detecting errors and/or for capturing error information,
a central database having teaching and training contents associated with the error information, for the further education of the operating personnel for future error avoidance, and
an output interface for providing teaching and/or training contents for the error-specific further education of the operating personnel in order to avoid in future the error that occurred.
